(19) United States
(12) Patent Application Publication
(10) Pub. No.: US 2020/0112267 A1
(43) Pub. Date: Apr. 9, 2020

(54) CONTROL CIRCUIT AND INFORMATION PROCESSING APPARATUS

(71) Applicant: FUJITSU LIMITED, Kawasaki-shi (JP)

(72) Inventor: HIROSHI SAKURAI, Kawasaki (JP)

(73) Assignee: FUJITSU LIMITED, Kawasaki-shi (JP)

(21) Appl. No.: 16/571,823

(22) Filed: Sep. 16, 2019

(30) Foreign Application Priority Data
Oct. 3, 2018 (JP) 2018-187927

(51) Int. Cl. H02M 7/539; H02M 1/14

(52) U.S. Cl. CPC H02M 7/539; H02M 1/143

(57) ABSTRACT

A control circuit configured to control a power supply circuit that converts an input DC into an AC by a switching process using a predetermined switching frequency, transforms the converted AC, rectifies the transformed AC, and outputs a DC obtained by smoothing the rectified AC to a load side, the control circuit includes a memory, and a processor coupled to the memory and configured to turn on a switch included in the power supply circuit to output a noise before the smoothing to the load side, measure a noise level of the load side, change the switching frequency, repeat measuring the noise level and changing the switching frequency a predetermined of times, determine the switching frequency to be set for the power supply circuit, based on noise levels obtained from measuring the noise level, and set the determined switching frequency.

### CROSS-REFERENCE TO RELATED APPLICATION

This application is based upon and claims the benefit of priority of the prior Japanese Patent Application No. 2018-187927, filed on Oct. 3, 2018, the entire contents of which are incorporated herein by reference.

### FIELD

The embodiments discussed herein are related to a control circuit and an information processing apparatus.

### BACKGROUND

In electronic calculators, a high level of integration accompanied by the miniaturization of devices and a high speed of an operation frequency of a CPU (central processing unit) and transfer speed have caused a tendency of an increase of noise, and thus, it has been difficult to secure a noise margin as a signal voltage becomes lowered.

Thus, in designing a printed circuit board, the noise margin is secured by considering many factors including a distribution topology of a signal, an arrangement of components, a wiring route or a wiring length, a control of undershoot or overshoot by an analysis of reflection, a control of timing for a signal output, a suppression of a fluctuation of a power supply voltage by a crosstalk or a sudden current fluctuation, an influence of an impedance characteristic between a power supply and a ground, etc., through a CAD (computer-aided design) simulation and an actual device evaluation.

In addition, as a measure to avoid an overlapping with other noises and reduce the noise of a switching power supply that occurs normally, there is known a measure to reduce the noise by dispersing the noise level by scrambling the switching frequency with a DC-DC converter or changing the frequency by avoiding the interference influence on other signal lines (see, e.g., Japanese Laid-open Patent Publication No. 2007-020379). Further, there are known technologies disclosed in Japanese Laid-open Patent Publication Nos. 2003-324944, 05-227649, 2012-173240, 2001-298952, 10-146044, 08-242579, 2007-124886, and 2017-192281.

### SUMMARY

According to an aspect of the invention, a control circuit configured to control a power supply circuit that converts an input DC into an AC by a switching process using a predetermined switching frequency, transforms the converted AC by a transformer, rectifies the transformed AC, and outputs a DC obtained by smoothing the rectified AC to a load side, the control circuit includes a memory, and a processor coupled to the memory and configured to turn on a switch included in the power supply circuit to output a noise before the smoothing to the load side, measure a noise level of the load side, change the switching frequency of the power supply circuit, repeat measuring the noise level of the load side and changing the switching frequency of the power supply circuit a predetermined of times, determine the switching frequency to be set for the power supply circuit, based on noise levels obtained from measuring the noise level, and set the determined switching frequency for the power supply circuit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating an actual measurement value and a design value of a frequency characteristic of impedance of a printed circuit board;

FIG. 2 is a view illustrating frequency characteristics of impedances of an ideal capacitor and an actual capacitor;

FIG. 3 is a view illustrating an equivalent circuit of the ideal capacitor;

FIG. 4 is a view illustrating an equivalent circuit of the actual capacitor;

FIG. 5 is a view illustrating an equivalent circuit of an actual impedance of a bypass capacitor;

FIG. 6 is a view illustrating a frequency characteristic of a combined impedance of multiple elements;

FIG. 7 is a view illustrating a frequency characteristic of an impedance/noise level of the printed circuit board;

FIG. 8 is a view illustrating an example of an equivalent circuit of the printed circuit board and a circuit of a DC/DC converter;

FIG. 9 is a configuration diagram of a server according to an embodiment;

FIGS. 10A and 10B are a block diagram of a power supply in the server according to an embodiment;

FIG. 11 is a detailed configuration diagram of the DC/DC converter according to an embodiment;

FIG. 12 is a functional block diagram of a BMC;

FIG. 13 is an equivalent circuit when a switch is in a short state;

FIGS. 14A and 14B are a flowchart of a control method according to an embodiment; and

FIG. 15 is a detailed configuration diagram of a DC/DC converter according to another embodiment.

### DESCRIPTION OF EMBODIMENTS

Due to the recent cost down, it has been difficult to employ high-priced components or increase the number of layers in a printed circuit board that have been done for the purpose of enhancing the noise margin, and thus, it has become more difficult to secure the noise margin.

Further, since not all the components which are mounted at the time of an initial design and thereafter are specified, it is difficult to carry out an evaluation or a simulation for all combinations.

Thus, an unexpected noise may occur by the impedance fluctuation which relies on a frequency according to the difference between the mounted components, a multi-sourcing of the components, a mounting of a compatible component, and an increase/decrease of the memory devices, CPUs, and I/O (input/output) cards, etc., and as a result, there are cases where an intermittent system down failure occurs, which are problematic.

Further, even when measures are performed such as scrambling of switching frequencies, or eliminating an overlapping of the same frequency of switching, etc., a large noise occurs unexpectedly in a case where the frequency to be scrambled includes an anti-resonance point of an impedance. As a result, there is a case where a failure such as a system down or the like may occur intermittently due to the malfunction of mounted components or circuits. As a measure for the system down failure, it is necessary to add a noise absorbing component in order to reduce the influence of noise on a malfunctioning signal line, carry out a remodeling such as altering a wiring route, increase the number of layers of a printed circuit board, change an arrangement of existing components, or repair/revise a printed circuit board by a reexamination of a wiring route, a wiring length, etc.

Further, in the related art, it has been difficult to trace and reduce an increase of noise caused from a fluctuation of an impedance characteristic with respect to a frequency according to an aging deterioration of components or a change in installation environment such as, for example, temperature and humidity.

Hereinafter, embodiments of a technology of reducing the switching noise will be described with reference to the accompanying drawings.

On a printed circuit board which is a load of a switching power supply, multiple capacitors, a coil, a resistance, a CPU, an IC element, etc., are mounted, and multiple resonance and anti-resonance frequency characteristics are present in a load impedance when viewed from the switching power supply. In addition, the load impedance characteristic varies according to an adoption of multiple multi-sourced compatible components, an increase/decrease of memories, CPUs, and I/O cards according to a customer requirement, an aging deterioration of components or a change in installation environment such as, for example, temperature and humidity. The switching noise occurs normally as long as power is supplied.

Since the latest CPU or memory requires multiple different DC (direct current) power supplies and is mounted with a large number of switching power supplies such as DC/DC converters, the reduction of the normal switching noise leads to the reduction of the entire noise level.

Embodiments of the present disclosure have paid attention to the fluctuation of the impedance characteristic with respect to the frequency of the load side according to a difference of mounted components in manufacturing, a mounting of multi-sourced components, an increase/decrease of memories, CPUs, and I/O cards, an aging deterioration of components, a change in installation environment such as, for example, temperature and humidity, etc. The embodiments promote the reduction of the switching noise by changing the switching frequency of the switching power supply (DC/DC converter) and a spurious frequency thereof to a frequency for avoiding the anti-resonance point of the impedance of the load side. As a result, the entire noise level is reduced, and an intermittent system down failure, etc., caused from the noise may be improved.

The noise of the switching power supply occurs when the switching frequency and the spurious frequency thereof become noise. Thus, when the noise of the switching power supply matches the anti-resonance component of the impedance characteristic of the load side, the noise is largely amplified in proportion to the size of the impedance, and thus, unexpected large switching noise occurs normally.

In an embodiment, a BMC (baseboard management controller) changes the switching frequency and forcibly outputs a switching pulse generated using the corresponding switching frequency to the load side to measure the noise level of the load side. The BMC sets the switching frequency of the DC/DC converter to a frequency at which the noise level of the load side becomes the lowest.

As a result, the switching frequency may avoid the anti-resonance frequency of the load side, so that the normal switching noise level is lowered, and the entire noise margin increases. Thus, it is possible to avoid an intermittent system down failure caused from an unexpected malfunction of a circuit.

Here, the frequency characteristic of the impedance of the printed circuit board will be described.

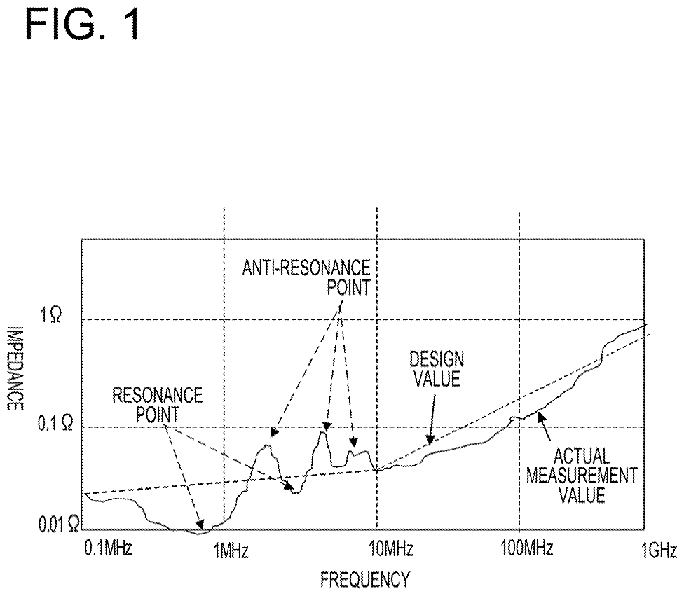

FIG. 1 is a view illustrating an actual measurement value and a design value of a frequency characteristic of an impedance of a printed circuit board. The vertical axis represents an impedance, and the horizontal axis represents a frequency.

In FIG. 1, the dashed line indicates the design value of the frequency characteristic of the impedance of the printed circuit board, and the solid line indicates the actual measurement value of the frequency characteristic of the impedance of the printed circuit board.

The design frequency characteristic of the impedance of the printed circuit board is represented as a combination of a first straight line that represents a frequency characteristic of 0 Hz to 10 MHz and a second straight line that has a different inclination from that of the first straight line and represents a frequency characteristic of 10 MHz to 1 GHz, as illustrated in the dashed line graph of FIG. 1.

However, the actual frequency characteristic of the impedance of the printed circuit board does not become the same as the design frequency characteristic. As illustrated in the solid line graph of FIG. 1, the actual frequency characteristic of the impedance of the printed circuit board has a resonance point where the impedance is locally small and an anti-resonance point where the impedance is locally large.

Next, a frequency characteristic of an impedance of a capacitor will be described.

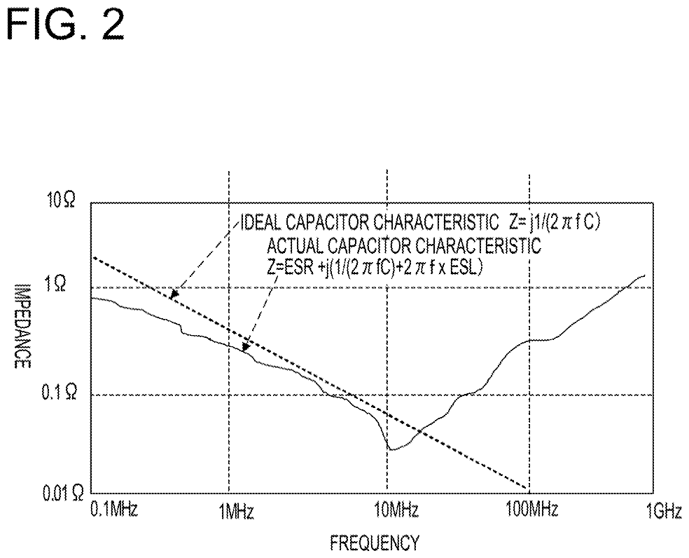

FIG. 2 is a view illustrating frequency characteristics of impedances of an ideal capacitor and an actual capacitor. The vertical axis represents an impedance, and the horizontal axis represents a frequency.

In FIG. 2, the dashed line represents the frequency characteristic of the impedance of the ideal capacitor, and the solid line represents the frequency characteristic of the impedance of the actual capacitor.

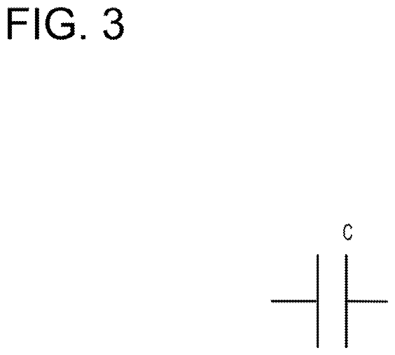

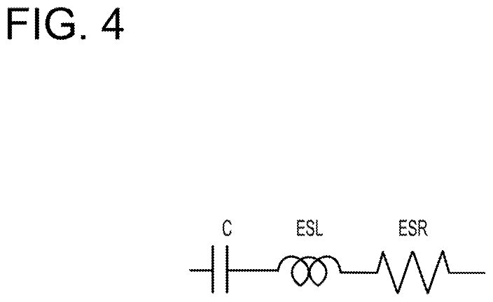

An equivalent circuit of the ideal capacitor is one capacitor as illustrated in FIG. 3, and an impedance Z is expressed as Z=j(1/(2nfC)). In addition, the j is an imaginary number unit, the f is a frequency, and the C is a capacitance. The frequency characteristic of the impedance of the ideal capacitor is represented as a straight line as illustrated in the dashed line graph of FIG. 2.

An equivalent circuit of the actual capacitor is a circuit in which a capacitance C, a resistance due to a loss of a dielectric, an electrode, etc., (equivalent series resistance (ESR)), and a parasitic inductance due to an electrode or a lead wire, etc., (equivalent series inductance (ESL)) are connected in series to each other.

The impedance Z of the equivalent circuit of the actual capacitor is represented as Z=ESR+j(1/(2nfC)+2nf*ESL). As for the frequency characteristic of the impedance of the actual capacitor, the impedance becomes small as the frequency increases to a specific frequency A. and becomes large as the frequency increases from the specific frequency A, as illustrated in the solid line graph of FIG. 2.

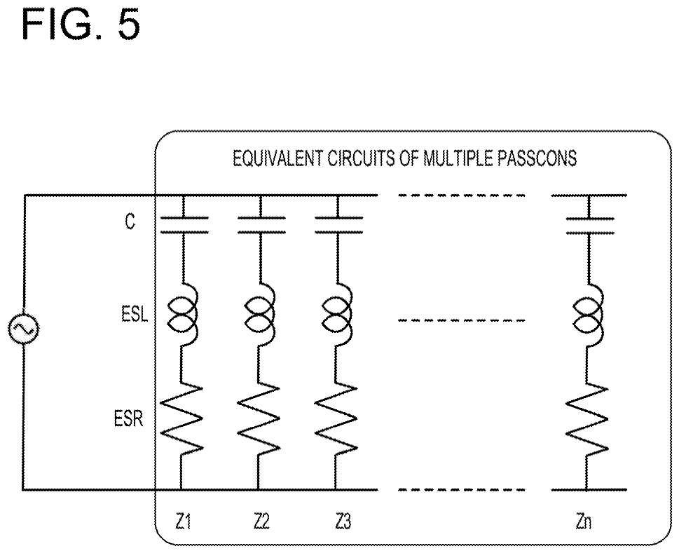

FIG. 5 is a view illustrating an equivalent circuit of an actual impedance of a bypass capacitor. Hereinafter, the bypass capacitor may be referred to as a passcon.

The impedances of passcons on the printed circuit board are represented by equivalent circuits of multiple passcons, etc., in FIG. 5. FIG. 5 illustrates equivalent circuits of N number of passcons 1 to N, and the impedances of the passcons 1 to N are Z1 to Zn, respectively.

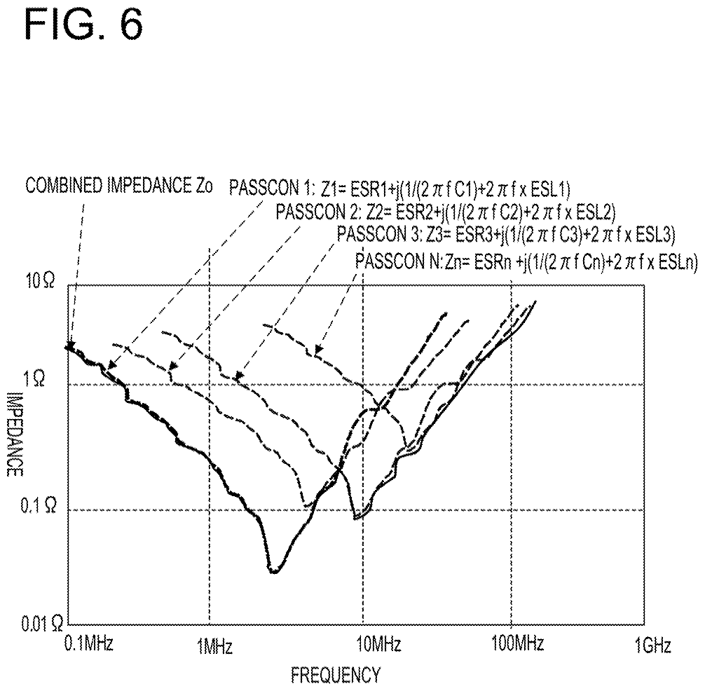

FIG. 6 is a view illustrating a frequency characteristic of a combined impedance of multiple elements. The vertical axis represents an impedance, and the horizontal axis represents a frequency.

As illustrated with the solid line of FIG. 6, a frequency characteristic of an impedance Zo of the printed circuit board is a combination of the characteristic in which multiple passcons or mounted components are connected in parallel, and the characteristic in which a resistance, a capacitance, and an inductance are connected in series. Further, the dashed lines of FIG. 6 indicate frequency characteristics of the impedances Z1 to Z3 and Zn of the passcons 1 to 3 and N, respectively. FIG. 6 omits the illustration of the frequency characteristics of the impedances Z4 to Zn−1 of the respective passcons 4 to N−1.

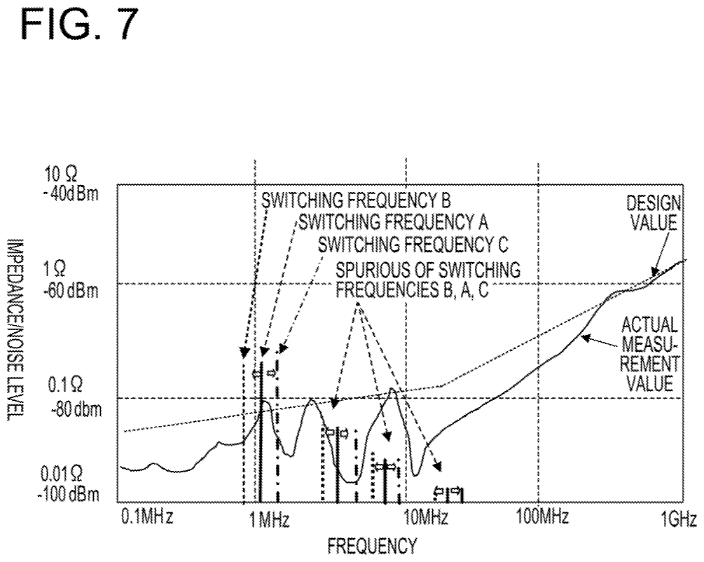

FIG. 7 is a view illustrating a frequency characteristic of an impedance/noise level of the printed circuit board. The vertical axis represents an impedance or a noise level, and the horizontal axis represents a frequency.

The frequency characteristic of the impedance of the printed circuit board varies according to passcons or IC elements mounted on the printed circuit board, a pattern and a feature of the printed circuit board, and an arrangement of components.

Thus, with the influence of mounted components including connectors on the actual printed circuit board or the feature of the printed circuit board, the frequency characteristic of the impedance of the printed circuit board is represented as the graph illustrated in FIG. 7. In FIG. 7, the dotted line indicates the design value of the frequency characteristic of the impedance of the printed circuit board, and the solid line indicates the actual measurement value of the frequency characteristic of the impedance of the printed circuit board.

Each of the first to third vertical lines from the left of FIG. 7 indicates a noise level, the dotted line indicates a noise level of a switching frequency B, the solid line indicates a noise level of a switching frequency A, and the alternate long and short dashed line indicates a noise level of a switching frequency C. In addition, the fourth to twelfth vertical lines from the left of FIG. indicate noise levels of a spurious group of the switching frequencies B, A and C.

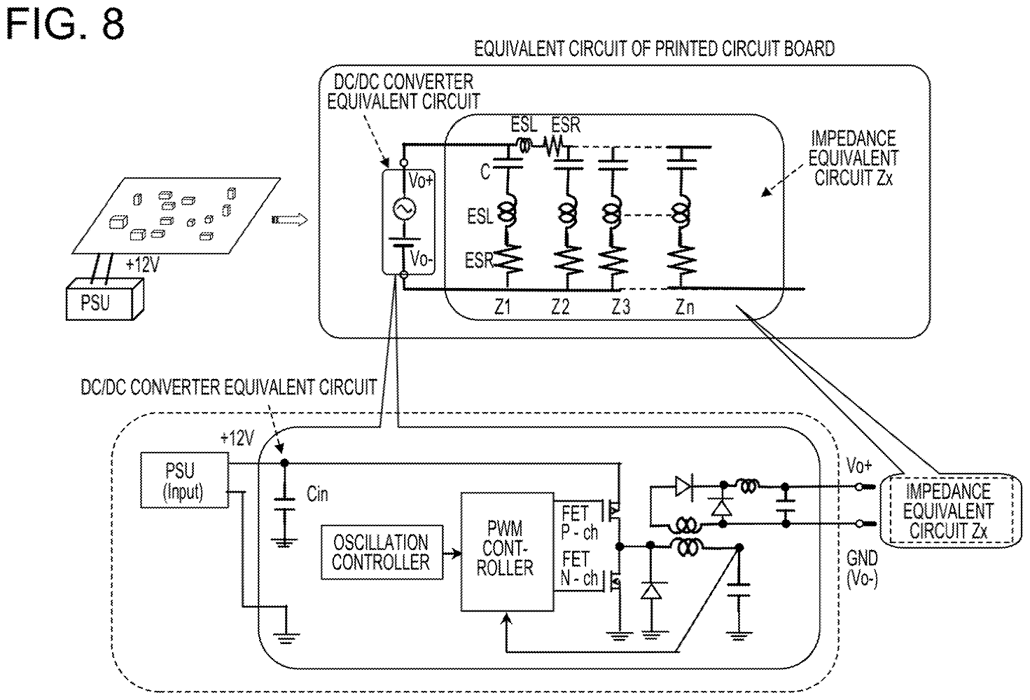

FIG. 8 is a view illustrating an example of the equivalent circuit of the printed circuit board and the circuit of the DC/DC converter.

The equivalent circuit of the actual printed circuit board illustrated in FIG. 8 has the impedance characteristic of the printed circuit board and the characteristic of the switching frequency illustrated in FIG. 7. When the switching frequency of the DC/DC converter mounted on the printed circuit board is each of the frequency B, the frequency A, and the frequency C, the noise levels of the spurious frequency group of the frequency ABC group correspond to the fourth to twelfth vertical lines from the left of FIG. 7. Accordingly, the impedance varies according to frequencies.

The BMC measures the impedance of the switching frequency used by the switching power supply (the DC/DC converter), for example, at the time when power is supplied or a hardware configuration is changed, and changes the switching frequency so as to set the switching frequency to a frequency at which the noise level comprehensively becomes the smallest. In addition, since the impedance is completely proportional to the noise level, the impedance may be measured by measuring the noise level.

As a result, it is possible to reduce the switching noise that occurs normally due to a difference of components, a mounting of a multi-sourced component, an increase of the number of memories, CPUs, and I/O cards, etc., so that it is possible to improve an intermittent system down failure, etc., caused from a logic contradiction of the internal circuits of an element or a malfunction due to the influence of noise, without changing the printed circuit board.

In addition, at the time of an error retry by an analysis of contents of an error log, an increase of corrective errors, an occurrence of an uncorrectable error or a fatal error, etc., the BMC re-measures an optimum value of the impedance. When the measurement result is different from a switching frequency that has been set, the BMC applies the re-measurement value to avoid the fluctuation of the impedance caused from an aging deterioration of mounted components or a change in installation environment such as, for example, temperature and humidity.

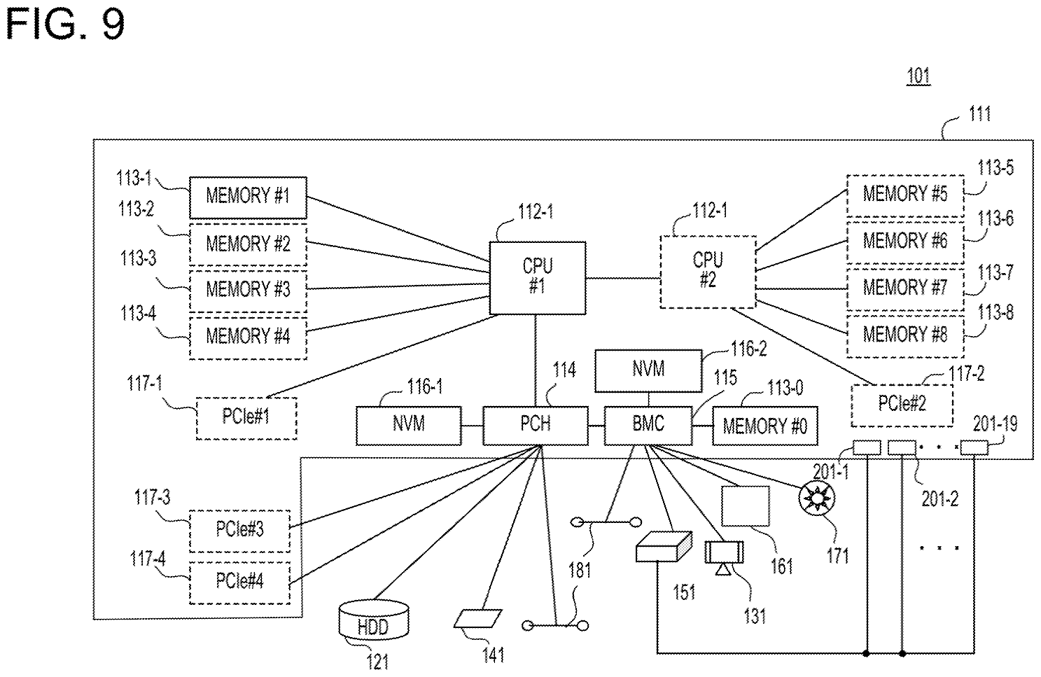

FIG. 9 is a configuration diagram of a server according to the embodiment.

A server 101 includes a printed circuit board 111, a CPU 112-1, a memory 113-1 (i=0, 1), a PCH (platform controller hub) 114, a BMC 115, and an NVM (non-volatile memory) 116-j (j=1, 2), a DC/DC converter 201-n (n=1 to 19), an HDD (hard disk drive) 121, a display device 131, a keyboard 141, a PSU (power supply unit) 151, a sensor 161, and a fan 171. The server 101 is an example of an information processing apparatus.

The CPU 112-1, the memory 113-i, the PCH 114, the BMC 115, the NVM 116-j, and the DC/DC converter 201-n are mounted on the printed circuit board 111. In addition, although not illustrated, components which are loads, such as a bypass capacitor, a resistance, a coil, an IC, etc., are further mounted on the printed circuit board 111.

The CPU 112-1 is a processor that executes various processes. The CPU 112-1 is an example of an arithmetic processing device.

The memory 113-0 stores programs, data or the like used by the BMC 115. The memory 113-1 stores programs, data or the like used by the CPU 112-1. The memory 113-i is, for example, a RAM (random access memory).

The PCH 114 controls an exchange of data among the CPU 112-1, the NVM 116-1, the BMC 115, the HDD 121, the keyboard 141, a LAN (local area network) 181, etc. Further, the PCH 114 is connected to the LAN 181, and is capable of communicating with a device connected via the LAN 181.

The BMC 115 controls the display device (e.g., LCD) 131, the PSU 151, the sensor 161, the fan 171, and the DC/DC converter 201-n. Further, the BMC 115 is connected to the LAN 181, and is capable of communicating with a device connected via the LAN 181. The BMC 115 is an example of a control circuit.

The NVM 116-1 stores programs, data or the like used by the CPU 112-1. The NVM 116-2 stores programs, data or the like used by the processor included in the BMC 115.

The DC/DC converter 201-n steps down the DC input from the PSU and outputs the stepped-down DC. The DC/DC converter 201-n converts an input voltage (e.g., 12 V) into a target voltage (e.g., 5 V) and outputs the converted voltage. The DC/DC converter 201-n is an example of a power supply circuit.

The HDD 121 is a magnetic storage device that stores programs, data or the like used by the server 101. In addition, the HDD 121 may be an SDD (solid state drive).

The display device 131 displays an inquiry to a user or an operator, or a processing result. The display device is, for example, an LCD (liquid crystal display).

The keyboard 141 is used to input an instruction or information from a user or an operator.

The PSU 151 is connected to an AC power supply (not illustrated), converts an input AC into a DC, and supplies the DC converted into a predetermined voltage (e.g., 12 V) to the DC/DC converter 201-n.

The sensor 161 acquires the state of the server 101, and is, for example, a temperature sensor that detects the temperature of the CPU 112-1 or the temperature inside the housing of the server 101.

For example, the fan 171 cools the CPU 112-1, introduces the outdoor air into the housing of the server 101, and exhausts the air inside the housing of the server 101.

In addition, the CPU 112-2, the memories 113-2 to 113-8, and PCIe (peripheral component interconnect express) devices 117-1 to 117-4 are optional components and may be mounted on the server 101 as necessary.

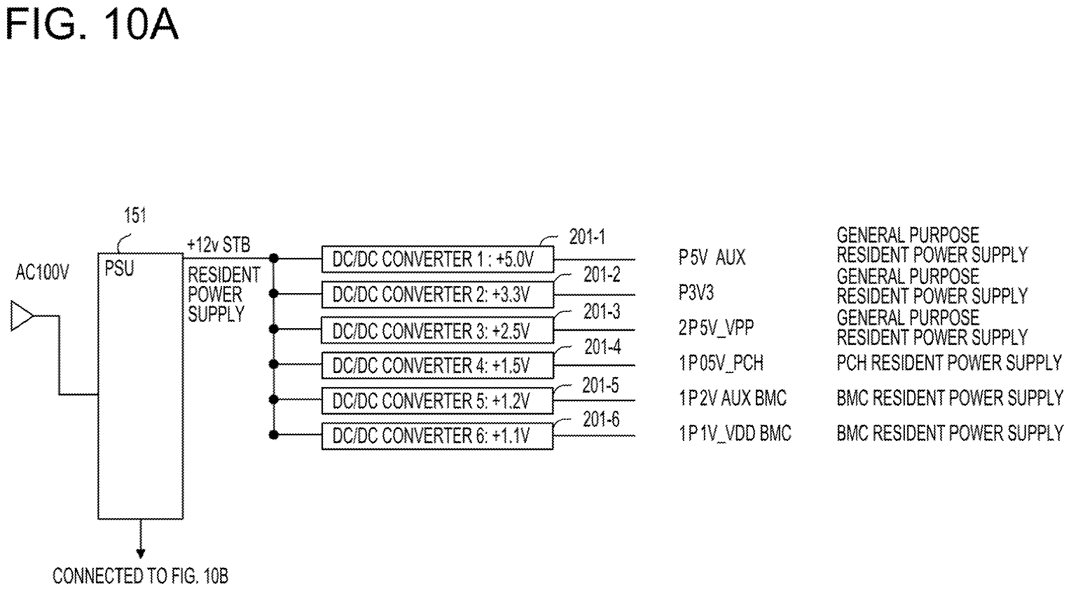

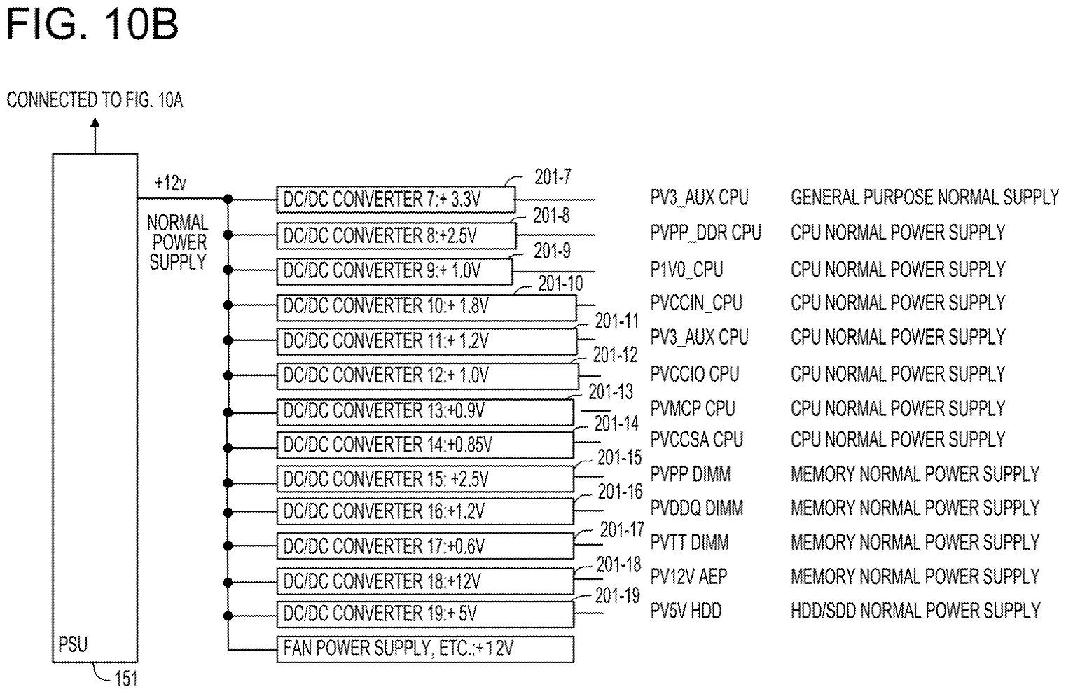

FIGS. 10A and 10B are a block diagram of a power supply in the server according to the embodiment.

The PSU 151 is connected to a 100 V AC power supply, converts an input AC into a DC, and supplies the DC converted into a predetermined voltage (12 V) to the DC/DC converter 201-n. Specifically, the PSU 151 includes a resident power supply and a normal power supply. When the PSU 151 is connected to the AC power supply, the resident power supply supplies power even in a state where the server 101 is not powered on. The normal power supply supplies power after the server 101 is powered on.

The resident power supply outputs a 12 V DC to the DC/DC converters 201-1 to 201-6, and the normal power supply outputs a 12 V DC to the DC/DC converters 201-7 to 201-19. Further, the normal power supply outputs a 12 V DC used for the driving of the fan 171, etc.

The DC/DC converter 201-1 converts the 12 V DC input from the resident power supply into a 5 V DC and outputs the converted DC. The DC output from the DC/DC converter 201-1 is used as a general-purpose resident power supply in the server 101.

The DC/DC converter 201-2 converts the 12 V DC input from the resident power supply into a 3.3 V DC and outputs the converted DC.

The DC/DC converter 201-3 converts the 12 V DC input from the resident power supply into a 2.5 V DC and outputs the converted DC.

The DC/DC converter 201-4 converts the 12 V DC input from the resident power supply into a 1.5 V DC and outputs the converted DC.

The DC/DC converter 201-5 converts the 12 V DC input from the resident power supply into a 1.2 V DC and outputs the converted DC.

The DC/DC converter 201-6 converts the 12 V DC input from the resident power supply into a 1.1 V DC and outputs the converted DC.

The DC/DC converter 201-7 converts the 12 V DC from the normal power supply into a 3.3 V DC and outputs the converted DC.

The DC/DC converter 201-8 converts the 12 V DC input from the normal power supply into a 2.5 V DC and outputs the converted DC.

The DC/DC converter 201-9 converts the 12 V DC input from the normal power supply into a 1.0 V DC and outputs the converted DC.

The DC/DC converter 201-10 converts the 12 V DC input from the normal power supply into a 1.88 V DC and outputs the converted DC.

The DC/DC converter 201-11 converts the 12 V DC input from the normal power supply into a 1.2 V DC and outputs the converted DC.

The DC/DC converter 201-12 converts the 12 V DC input from the normal power supply into a 1.0 V DC and outputs the converted DC.

The DC/DC converter 201-13 converts the 12 V DC input from the normal power supply into a 0.9 V DC and outputs the converted DC.

The DC/DC converter 201-14 converts the 12 V DC input from the normal power supply into a 0.85 V DC and outputs the converted DC.

The DC/DC converter 201-15 converts the 12 V DC input from the normal power supply into a 2.5 V DC and outputs the converted DC.

The DC/DC converter 201-16 converts the 12 V DC input from the normal power supply into a 1.2 V DC and outputs the converted DC.

The DC/DC converter 201-17 converts the 12 V DC input from the normal power supply into a 0.6 V DC and outputs the converted DC.

The DC/DC converter 201-18 converts the 12 V DC input from the normal power supply into a 12 V DC and outputs the converted DC. The DC output from the DC/DC converter 201-18 is used as a normal power supply of the memory 113-i.

The DC/DC converter 201-19 converts the 12 V DC input from the normal power supply into a 5 V DC and outputs the converted DC. The DC output from the DC/DC converter 201-19 is used as a normal power supply of the memory 113-i.

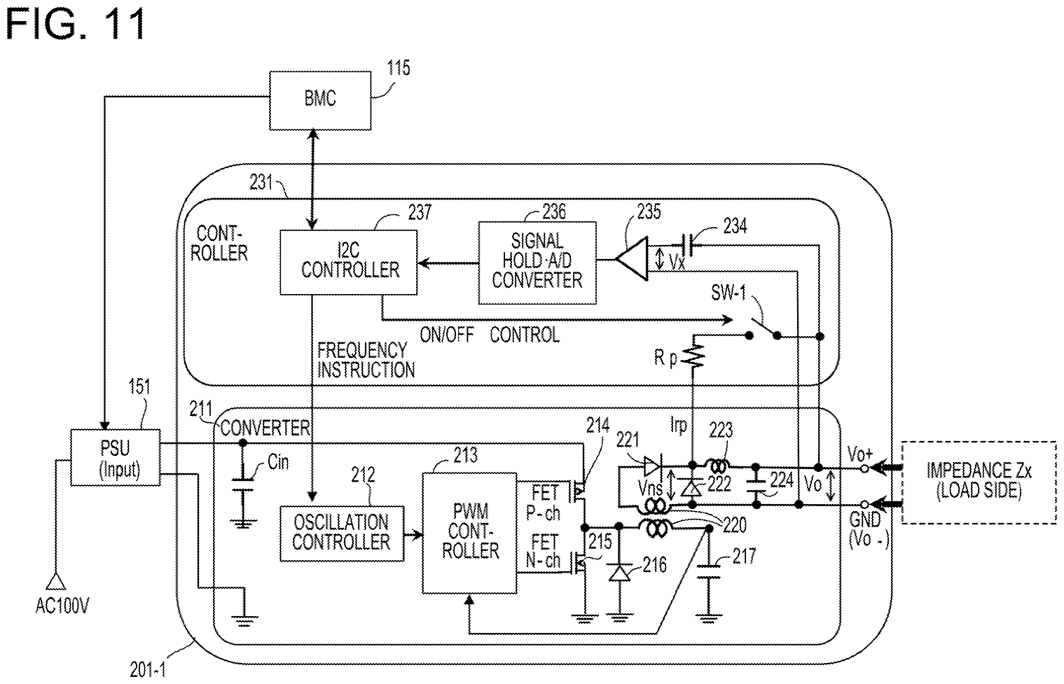

FIG. 11 is a detailed configuration diagram of the DC/DC converter according to the embodiment.

The DC/DC converter 201-1 includes a converter 211 and a controller 231.

The converter 211 is divided by a transformer 220 into a primary side circuit and a secondary side circuit. The primary side circuit includes a bypass capacitor Cin, an oscillation controller 212, a PWM (pulse width modulation) controller 213, FETs (field effect transistors) 214 and 215, a diode 216, and a capacitor 217. The oscillation controller 212 receives a frequency instruction from an I2C (inter-integrated circuit) controller 237, sets the instructed frequency (the switching frequency), and outputs a pulse of the set frequency to the PWM controller 213. The PWM controller 213 performs a PWM control of the FETs 214 and 215 using the pulse input from the oscillation controller 212. The PWM control is a control for adjusting the ON/OFF time, that is, a duty cycle by making a period (frequency) constant.

The FET 214 is a P-channel MOS FET (metal oxide semiconductor field effect transistor). The FET 215 is an N-channel MOS FET. The FET 214 is an example of a switching element. The FET 214 causes the DC from the PSU to pass through the transformer 220 or blocks the DC, under the control of the PWM controller 213. That is, the FET 214 converts the DC from the PSU into an AC, and inputs the converted AC to the transformer 220. The PWM controller 213 turns ON and OFF (switching) the FETs 214 and 215 using the pulse of the switching frequency, such that the DC from the PSU 151 is chopped, and an AC signal of the switching frequency is input to the primary side of the transformer 220. When the AC signal of the switching frequency is input to the primary side of the transformer 220, an AC signal of the stepped-down switching frequency is generated to the secondary side of the transformer 220.

The secondary side circuit includes diodes 221 and 222, a coil 223, and a capacitor 224. The diodes 221 and 222 constitute a rectification circuit, and rectify full waves of the AC signal from the transformer 220. The coil 223 and the capacitor 224 constitute a smoothing circuit, smooth the signal of which full waves have been rectified, and output the smoothed signal (DC) to the load.

Although a device or the like to which the DC converted by the DC/DC converter 201-1 is to be supplied is actually connected to the output destination (load side) of the converter 211, FIG. 11 illustrates an impedance Zx that is connected to the load side, for the simplification of description. Here, the output voltage of the rectification circuit (the diodes 221 and 222) is Vns, and the output voltage of the conversion unit 211 is Vo

The controller 231 includes a resistance Rp, a switch SW-1, a capacitor 234, an operational amplifier 235, a signal hold⋅A/D converter 236, and the I2C controller 237.

The resistance Rp is provided between the switch SW-1 and the cathodes of the diodes 221 and 222 (the output of the rectification circuit).

When the switch SW-1 is ON (in the short state), the noise after the AC signal of the switching frequency generated to the secondary side of the transformer 220 is rectified by the rectification circuit is forcibly input to the load side. In the embodiment, the signal rectified by the rectification circuit and input to the load side via the switch SW-1 is the unsmoothed signal and includes a switching noise. When the switch SW-1 is OFF (in the open state), the AC signal of the switching frequency generated to the secondary side of the transformer 220 is rectified by the rectification circuit, and a DC voltage obtained by smoothing the rectified signal in the rectification circuit is input as the output voltage Vo of the power supply to the load side. The switch SW-1 is controlled by the BMC 115 via the I2C controller 237.

The capacitor 234 is a capacitor for an AC coupling, is connected between the output of the converter 211 and the input of the load side, and outputs an AC component (noise) of an input signal (voltage) to the operational amplifier 235. The output voltage of the capacitor 234 is set as a noise level Vx. The capacitor 234 outputs the noise level of the load side for the signal input to the load side.

The operational amplifier 235 outputs the noise level Vx from the capacitor 234 to the signal hold⋅A/D converter 236. The signal hold⋅A/D converter 236 holds a peak value of the noise level Vx input from the operational amplifier 235, and outputs the peak value of the noise level Vx to the I2C controller 237.

The I2C controller 237 is connected to the BMC 115 via I2C, to receive an instruction of the switching frequency from the BMC 115 and instruct the received switching frequency to the oscillation controller 212. Further, the I2C controller 237 outputs the noise level Vx input from the signal hold⋅A/D converter 236 to the BMC 115.

In addition, since the configuration of each of the DC/DC converters 201-2 to 201-19 is the same as the configuration of the DC/DC converter 201-1, descriptions thereof will be omitted.

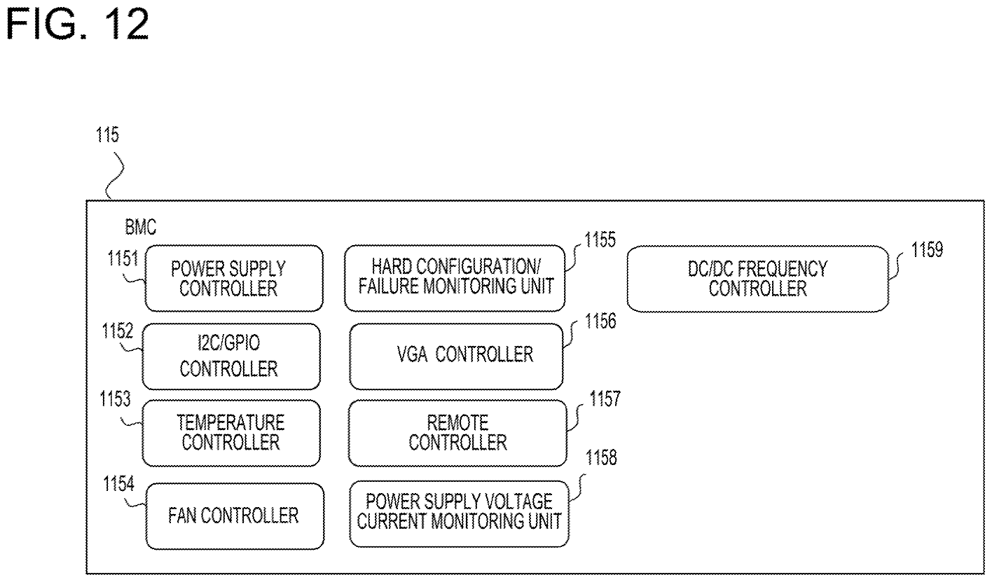

FIG. 12 is a functional block diagram of the BMC.

The BMC 115 includes a power supply controller 1151, an I2C/GPIO (general-purpose input/output) controller 1152, a temperature controller 1153, a fan controller 1154, a hardware configuration/failure monitoring unit 1155, and a VGA (video graphics array) controller 1156, a remote controller 1157, a power supply voltage current monitoring unit 1158, and a DC/DC frequency controller 1159.

The power supply controller 1151 controls the resident power supply and the normal power supply from the PSU 151.

The I2C/GPIO controller 1152 controls a communication in a server or a communication between the server 101 and an external device using I2C or GPIO.

The temperature controller 1153 performs a control based on the temperature of each component (e.g., a CPU or the like) of the server 101.

The fan controller 1154 controls the number of rotations of the fan 171.

The hardware configuration/failure monitoring unit 1155 monitors the components of the server 101 and a presence/absence of a failure in the components of the server 101.

The VGA controller 1156 controls a display of the display device 131.

The remote controller 1157 transmits information of the server 101 (e.g., the hardware configuration, the presence/absence of a failure, the temperature, etc.) according to a request from a device connected via the LAN 181.

The power supply voltage current monitoring unit 1158 monitors the voltages and the currents of the PSU 151 and the DC/DC converter 201-n.

The DC/DC frequency controller 1159 controls the switching frequency of the DC/DC converter 201-n.

The DC/DC frequency controller 1159 forcibly outputs a switching pulse based on a specific switching frequency A to the load side, to measure the noise level of the response of the load side. In addition, the DC/DC frequency controller 1159 may calculate an impedance for the switching frequency from the measured noise level. While changing the switching frequency, the DC/DC frequency controller 1159 measures the noise level of the response of the load side for each of multiple switching frequencies.

Based on the measured noise level of the load side, the DC/DC frequency controller 1159 sets the switching frequency at which the noise level is the lowest, for the DC/DC converter 201-n.

As a result, since the switching frequency may avoid the anti-resonance frequency of the load side so that the level of the normal switching noise decreases and the entire noise margin increases, it is possible to avoid an intermittent system down failure or the like caused from an unexpected to malfunction of a circuit.

Here, descriptions will be made on a method of measuring the impedance Zx of the load when viewed from the DC/DC converter 201-n.

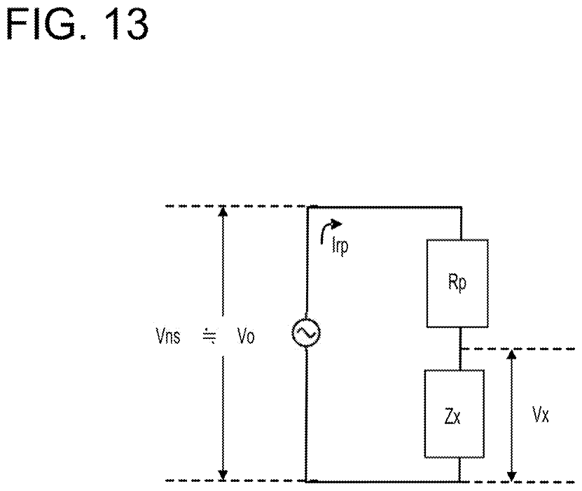

FIG. 13 is an equivalent circuit when the switch SW-1 is in the short state.

FIG. 13 represents the equivalent circuit when the switch SW-1 of the DC/DC converter 201-1 is ON (in the short state). In the equivalent circuit of FIG. 13, the resistance Rp and the impedance Zx (load) are connected in series, such that a current Irp of a switching pulse is input as noise to the resistance Rp and the impedance Zx.

Since an effective value Vo of a switching pulse voltage Vns is substantially the same as the switching pulse voltage Vns (Vns≈Vo), the DC/DC frequency controller 1159 may measure the noise level Vx of the load so as to calculate the impedance Zx from a known resistance value Rp and a known output voltage Vo using Equations (1) to (4) below. In this way, the DC/DC frequency controller 1159 may measure an execution value of the impedance Zx as illustrated in FIG. 7.

Vo=(Rp+Zx)*Irp (1)

Vx=Vo*Zx/(Rp+Zx) (2)

Irp=(Vo−Vx)/Rp (3)

Zx=Rp*Vx/(Vo−Vx) (4)

In addition, when an increase/decrease value of the impedance is measured during the operation of the CPU of the system, the increase/decrease of the impedance may be measured by the increase/decrease of the noise level Vx by making the switch SW-1 in the open state. At this time, since there is an influence of a crosstalk or the like accompanied by the operation of the CPU, other than the switching noise to be measured, the DC/DC frequency controller performs the measurement until the switching frequency at which the impedance becomes the smallest value is detected twice or more with the same value. Since the specific switching frequency may be changed during the operation of the system, the BMC 115 may check a presence/absence of an error retry, an increase/decrease of corrective errors, an occurrence of an uncorrectable error or a fatal error, etc., for the specific switching frequency according to an instruction of the BMC 115.

When a setting of an optimum switching frequency is performed, the BMC 115 makes the switch SW-1 in the short state, forcibly inputs a switching pulse, changes the switching frequency in a unit of X KHz within a changeable frequency range from an upper limit (C MHz) to a lower limit (B MHz), measures the noise level Vx of the load side, and finds out the switching frequency at which the noise level Vx becomes small and the noise margin becomes large. Then, the BMC 115 sets the found-out switching frequency for the DC/DC converter 201-n.

In addition, when the increase/decrease value of the impedance is measured during the operation of the CPU of the system, the switch SW-1 is opened, and then, the switching frequency is scanned until the switching frequency at which the noise level Vx becomes the smallest value may be detected twice or more with the same value, in order to avoid the influence of a crosstalk, an external noise, etc., other than the switching noise as described above.

In addition, since the switching frequency is set within an allowable design range at the time of the design according to a size of a coil shape of a solenoid, a power supply efficiency, and a response speed to a voltage fluctuation, the switching frequency may be changed within the allowable range.

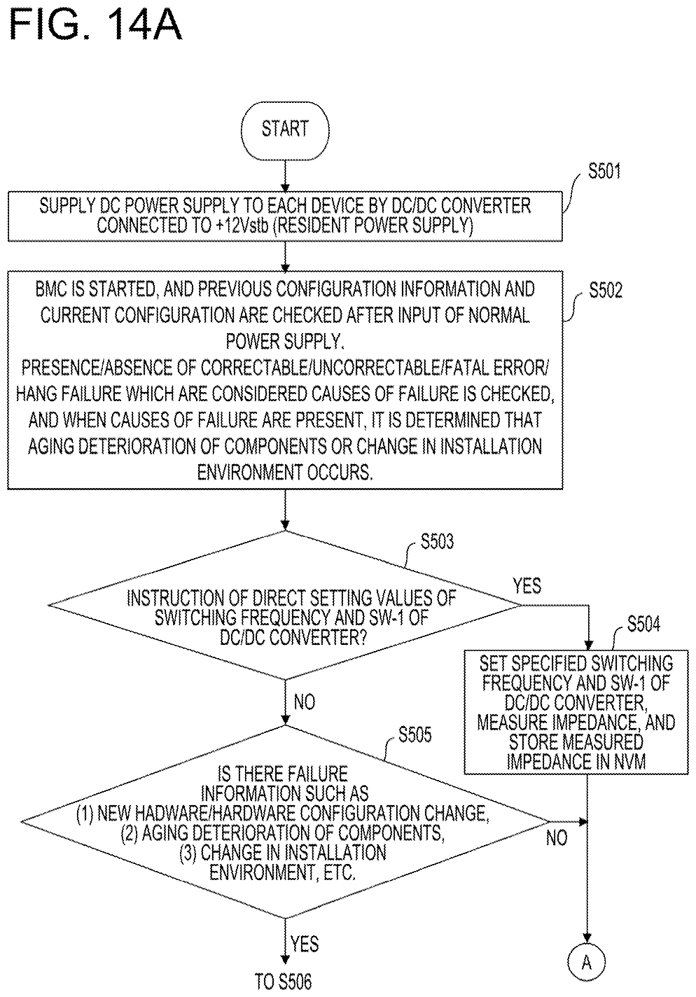

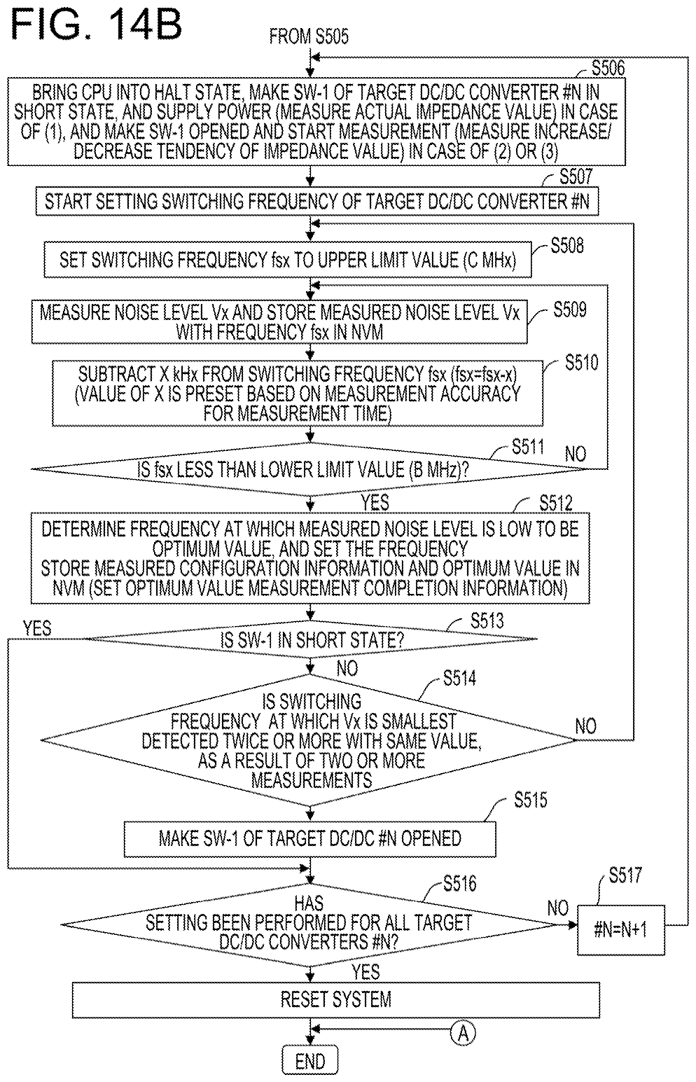

FIGS. 14A and 14B are a flowchart of a control method according to the embodiment.

First, the PSU 151 is connected to the AC power supply, and the resident power supply of the PSU 151 starts the supply of power.

In operation S501, each of the DC/DC converters 201-1 to 201-6 connected to the resident power supply supplies the DC to a supply destination device thereof.

In operation S502, the BMC 115 is started, and the DC/DC frequency controller 1159 checks the previous configuration information of the server 101 and the current configuration of the server 101 after the input of the normal power supply, and determines whether a new component has been added or a change has occurred. The DC/DC frequency controller 1159 checks a presence/absence of a correctable error, an uncorrectable error, a fatal error, and a hang failure which are considered as causes of noise in the log. When any one of the correctable error, the uncorrectable error, the fatal error, and the hang failure is present, the DC/DC frequency controller 1159 determines that an aging deterioration of components or a change in installation environment occurs. In addition, the configuration information and the log are stored in the NVM 116-2. In the embodiment, when multiple DC/DC converters 201-n are targets for the control of the switching frequency, it is assumed that # N=1, and the DC/DC converter # N is set as a DC/DC converter which is a setting target. In addition, the DC/DC converter 201-N will be referred to as the DC/DC converter # N.

In operation S503, the DC/DC frequency controller 1159 determines whether the DC/DC converter 201-n of the setting target, the value of the switching frequency, and ON/OFF of the switch SW-1 are directly specified. When it is determined that the DC/DC converter 201-n of the setting target, the value of the switching frequency, and ON/OFF of the switch SW-1 are directly specified, the control proceeds to operation S504, and otherwise, the control proceeds to operation S505. The information on the directly specified DC/DC converter 201-n of the setting target, value of the switching frequency, and ON/OFF of the switch SW-1 is stored in, for example, the NVM 116-2.

In operation S504, the DC/DC frequency controller 1159 sets the specified DC/DC converter 201-n, switching frequency, and ON/OFF of the switch SW-1, and measures the impedance Zx of the load for the set switching frequency. The DC/DC frequency controller 1159 stores the measured impedance in the NVM 116-2.

In operation S505, when there is (1) an addition of new hardware (component) or a change of hardware in the server 101, (2) an aging deterioration of components of the server 101, or (3) a change in installation environment of the server 101, the control proceeds to operation S506. When (1) to (3) do not occur, the process is ended.

In operation S506, when there is (1) an addition of new hardware (component) or a change of hardware in the server 101, the DC/DC frequency controller 1159 brings the CPU 112-1 into a HALT state (the stop state of the operation clock of the CPU 112-1) to turn ON the switch SW-1 of the target DC/DC converter # N (in the short state), forcibly outputs the switching pulse to the load side, and starts the measurement of the noise level of the load side. When the CPU 112-1 is brought into the HALT state, it is possible to reduce the influence of a crosstalk, etc., accompanied by the operation of the CPU, other than the switching noise. The DC/DC frequency controller 1159 may calculate the impedance from the measured noise level according to the following process.

When there is (2) an aging deterioration of components of the server 101 or (3) a change in installation environment of the server 101, the DC/DC frequency controller 1159 turns OFF the switch SW-1 of the target DC/DC converter # N (in the open state), and starts the measurement of the noise level of the load side. The DC/DC frequency controller 1159 measures the tendency of the increase/decrease of the impedance value.

In operation S507, the DC/DC frequency controller 1159 starts the setting of the switching frequency of the target DC/DC converter # N.

In operation S508, the DC/DC frequency controller 1159 sets a switching frequency (fsx) of the target DC/DC converter # N to the upper limit value (C MHz). Specifically, the DC/DC frequency controller 1159 instructs the upper limit value of the switching frequency to the oscillation controller 212 via the I2C controller 237. The oscillation controller 212 outputs a pulse signal (rectangular wave) of the instructed switching frequency to the PWM controller 213. As described in FIG. 11, when the switch SW-1 is ON, a signal based on the set switching frequency is forcibly output to the load side via the switch SW-1. When the switch SW-1 is OFF, a DC of which voltage has been converted by the converter 211 using the set switching frequency is output to the load side.

In operation S509, the DC/DC frequency controller 1159 measures the noise level Vx of the load side, and stores the measured noise level Vx and the switching frequency in the NVM 116-2. That is, the DC/DC frequency controller 1159 receives the noise level Vx via the operational amplifier 235, the signal hold⋅A/D converter 236, and the I2C controller 237, and stores the received noise level Vx and the switching frequency in the NVM 116-2. In addition, in the embodiment, the DC/DC frequency controller 1159 may calculate the impedance Zx from the measured noise level, to use the impedance Zx, instead of the noise level Vx.

In operation S510, the DC/DC frequency controller 1159 subtracts a predetermined value (X kHz) from the current switching frequency fsx, to calculate a switching frequency fsx to be newly set, and sets the new switching frequency for the target DC/DC converter # N. In addition, the predetermined value is preset based on a measurement accuracy for a measurement time.

In operation S511, the DC/DC frequency controller 1159 determines whether the set switching frequency fsx is less than the lower limit value (B MHz). When it is determined that the set switching frequency fsx is less than the lower limit value (B MHz), the control proceeds to operation S512, and when it is determined that the set switching frequency fsx is equal to or more than the lower limit value (B MHz), the control returns to operation S509.

In operation S512, the DC/DC frequency controller 1159 determines the switching frequency that corresponds to the lowest noise level Vx among measured noise levels Vx, to be an optimum value, and sets the switching frequency of the target DC/DC converter # N to the optimum value. Further, the DC/DC frequency controller 1159 stores the measured configuration information of the server 101 and the determined optimum value as optimum value measurement completion information, in the NVM 116-2. Since the noise level Vx and the impedance Zx are proportional to each other, the switching frequency that corresponds to the lowest noise level Vx is determined to be the optimum value, so that the switching frequency at which the impedance Zx is the lowest may be determined.

In operation S513, when the switch SW-1 of the target DC/DC converter # N is ON (in the short state), the control proceeds to operation S515, and when the switch SW-1 is OFF (opened), the control proceeds to operation S514.

In operation S514, when the determination of the optimum value of the switching frequency of the target DC/DC converter # N is performed twice or more, and the switching frequency that corresponds to the lowest noise level Vx (=optimum value) has the same value twice or more, the control proceeds to operation S515. When the determination of the optimal value of the switching frequency of the target DC/DC converter # N is not performed twice or more or the switching frequency that corresponds to the lowest noise level Vx (=optimum value) has the same value twice or more, the control returns to operation S508.

In operation S515, the switch SW-1 of the target DC/DC converter # N is turned OFF (opened).

In operation S516, when all the switching frequencies of the DC/DC converters 201-n of the setting target are set to the optimum value, the control proceeds to operation S518, and when there is a DC/DC converter 201-n of which switching frequency is not yet set to the optimum value, the control proceeds to operation S517. For example, in the embodiment, in a case where the DC/DC frequency controller 1159 sets the switching frequencies of the DC/DC converter 201-1 to 201-19, the control proceeds to operation S518 when # N=19, and the control proceeds to operation S517 when # N<19.

In operation S517, the DC/DC frequency controller 1159 increments # N by one, and the control returns to operation S506.

In operation S518, the DC/DC frequency controller 1159 resets the server 101 (system reset).

According to the embodiment, the switching frequency of the DC/DC converter may be set to a switching frequency at which the impedance Zx is the lowest. As a result, the switching noise is reduced, and the entire noise level is also reduced, so that an intermittent system down failure or the like caused from noise may be improved.

According to the embodiment, even when there are a replacement mounting of a compatible component, an increase of memories, CPUs, and 10 cards, etc., the switching noise that occurs normally may be reduced, and the entire noise level of the system may also be reduced, without changing the printed circuit board. As a result, the noise margin may increase even for an asynchronously and intermittently occurring simultaneous change of signal lines or an external noise, and it is possible to avoid a system down failure or the like even in a system with a relatively small noise margin, so that the influence of radiation noise from the outside is also reduced.

Further, according to the embodiment, at the time of an occurrence of an error retry by an analysis of contents of an error log in the BMC, an increase of corrective errors, an occurrence of an uncorrectable error or a fatal error, etc., the impedance is re-measured, and when the optimum value of the set switching frequency is different from the previous setting value, it is determined that a fluctuation of the impedance occurs due to an aging deterioration of mounted components or a change in installation environment such as, for example, temperature and humidity, so that it is possible to reduce the number of corrective errors or avoid a failure in memories, a bus, etc., by re-setting the switching frequency to the optimum value.

In addition, the noise level Vx may be measured every time power is supplied or a reset is carried out, or may be measured by an external trigger.

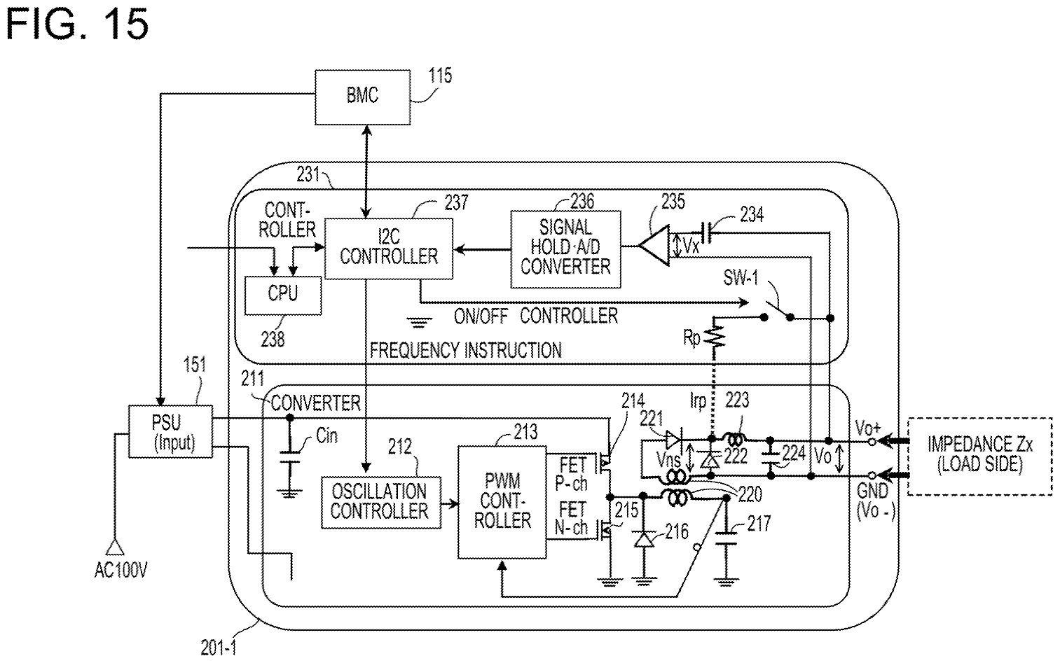

FIG. 15 is a detailed configuration diagram of a DC/DC converter according to another embodiment.

The DC/DC converter 201-1 according to another embodiment includes a converter 211 and a controller 231. The components of the converter 211 according to another example are the same as those of the converter 211 of FIG. 11. The controller 231 includes the resistance Rp, the switch SW-1, the capacitor 234, the operational amplifier 235, the signal hold⋅A/D converter 236, the I2C controller 237, and the CPU 238.

In addition, in FIG. 15, the components having the same functions as those of the components of the DC/DC converter 201-1 of the embodiment of FIG. 11 will be denoted by the same reference numerals as used in FIG. 11, and descriptions thereof will be omitted.

The controller 231 according to another embodiment further includes the CPU 238, as compared with the controller 211 of FIG. 11. In another embodiment, the CPU 238 has the function of the DC/DC frequency controller 1159, and operates as the DC/DC frequency controller 1159. In that case, the BMC 115 may not have the function of the DC/DC frequency controller 1159. The CPU 238 that operates as the DC/DC frequency controller 1159 is an example of a control circuit. According to another embodiment, the load of the BMC 115 may be reduced, and the optimization of the switching frequency may be implemented by the DC/DC converter 201-1 alone, without using the BMC 115.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A control circuit configured to control a power supply circuit that converts an input DC into an AC by a switching process using a predetermined switching frequency, transforms the converted AC by a transformer, rectifies the transformed AC, and outputs a DC obtained by smoothing the rectified AC to a load side, the control circuit comprising:
a memory; and
to a processor coupled to the memory and configured to:
turn on a switch included in the power supply circuit to output a noise before the smoothing to the load side;
measure a noise level of the load side;
change the switching frequency of the power supply circuit;
repeat measuring the noise level of the load side and changing the switching frequency of the power supply circuit a predetermined of times;
determine the switching frequency to be set for the power supply circuit, based on noise levels obtained from measuring the noise level; and
set the determined switching frequency for the power supply circuit.

2. The control circuit according to claim 1,
wherein the processor is configured to determine the switching frequency that corresponds to a smallest noise level among the noise levels obtained from measuring the noise level, to be the switching frequency to be set for the power supply circuit.

3. The control circuit according to claim 1,
wherein the processor is further configured to:
stop an operation of an arithmetic processing device included in an information processing apparatus in which the control circuit is included; and
measure the noise level of the load side after stopping the operation of the arithmetic processing device.

4. An information processing apparatus comprising:
a power supply circuit configured to:
convert an input DC into an AC by a switching process using a predetermined switching frequency,
transform the converted AC by a transformer,
rectify the transformed AC, and
to output a DC obtained by smoothing the rectified AC to a load side,
a control circuit configured to include:
a memory, and
a processor coupled to the memory and configured to:
turn on a switch included in the power supply circuit to output a noise before the smoothing to the load side,
measure a noise level of the load side,
change the switching frequency of the power supply circuit,
repeat measuring the noise level of the load side and changing the switching frequency of the power supply circuit a predetermined of times,
determine the switching frequency to be set for the power supply circuit, based on noise levels obtained from measuring the noise level, and
set the determined switching frequency for the power supply circuit.

5. The information processing apparatus according to claim 4,
wherein the processor is configured to determine the switching frequency that corresponds to a smallest noise level among the noise levels obtained from measuring the noise level, to be the switching frequency to be set for the power supply circuit.

6. The information processing apparatus according to claim 4,
wherein the processor is further configured to:
stop an operation of an arithmetic processing device included in the information processing apparatus, and
measure the noise level of the load side after stopping the operation of the arithmetic processing device.
